(19) United States
(12) Patent Application Publication
(10) Pub. No.: US 2012/0184247 A1
(43) Pub. Date: Jul. 19, 2012

(54) ELECTRONIC DEVICE AND METHOD OF CONTROLLING THE SAME

(75) Inventors: Dami CHOE, Seoul (KR); Seungyong PARK, Seoul (KR)

(73) Assignee: LG ELECTRONICS INC., Seoul (KR)

(21) Appl. No.: 13/009,523

(22) Filed: Jan. 19, 2011

(51) Int. Cl. H04W 12/08; G06F 7/04

(52) U.S. Cl. 455/411; 340/5.54

(57) ABSTRACT

An electronic device comprises a touch screen and a controller for, in case where the electronic device is in a lock mode, simultaneously displaying a plurality of regions corresponding to a plurality of screens in the touch screen and, in case where a predetermined touch action is received through the touch screen, unlocking the lock mode and entering a screen corresponding to a region corresponding to the received touch action, from among the plurality of regions.

This application claims the benefit of Korean Patent Application No. 10-______-______ filed on ______, ______, which is hereby incorporated by reference.

### BACKGROUND

1. Field

This document relates to an electronic device and a method of controlling the same.

2. Related Art

In various electronic device fields including mobile terminals, with the help of the rapid development of software and hardware, a variety of functions are being supplied to users.

Accordingly, there is an increasing need for the development and supply of various user interfaces which enable users to easily and efficiently control electronic devices providing various and complicated functions.

### SUMMARY

An aspect of this document is to provide an electronic device providing user interfaces, enabling a user to control the electronic device easily and efficiently, and a method of controlling the same.

Another aspect of this document is to provide an electronic device providing a user interface, enabling a user to directly access a desired screen or a desired application execution screen in the state in which the electronic device is in a lock mode, and a method of controlling the same.

Yet another aspect of this document is to provide an electronic device and a method of controlling the same, which are capable of efficiently informing a user of the generation of an event or the contents of the event or both when the event related to the electronic device is generated in the state in which the electronic device is in a lock mode.

The technical objects to be achieved by this document are not limited to the above objects. Furthermore, other technical objects to be achieved by this document will be evident to a person having ordinary skill in the art from the following description.

An electronic device according to an aspect of this document comprises a touch screen; and a controller configured to display a plurality of regions on the touch screen when the touch screen is in a lock mode, the plurality of regions being corresponding to a plurality of screens and, when a predetermined touch action is received through the touch screen, to unlock the lock mode and enter a screen corresponding to a region corresponding to the received touch action, from among the plurality of regions.

A method of controlling an electronic device comprising a touch screen according to another aspect of this document comprises, displaying a plurality of regions on the touch screen when the touch screen is in a lock mode, the plurality of regions being corresponding to a plurality of screens and, when a predetermined touch action is received through the touch screen in the lock mode, unlocking the lock mode and entering a screen corresponding to a region corresponding to the received touch action, from among the plurality of regions.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a block diagram of an electronic device which is related to an embodiment of this document;

FIG. 2 is a conceptual diagram illustrating the proximity depth of a proximity sensor;

FIG. 3 is a flowchart illustrating a method of controlling an electronic device according to a first embodiment of this document;

FIGS. 4 and 5 are diagrams illustrating examples in which a plurality of regions is provided in the lock mode according to a first embodiment of this document;

FIG. 6 is a flowchart illustrating a method of controlling an electronic device according to a second embodiment of this document;

FIGS. 7 to 12 are diagrams illustrating examples in which the method of controlling the electronic device according to the second embodiment of this document is implemented;

FIG. 13 is a flowchart illustrating a method of controlling an electronic device according to a third embodiment of this document;

FIGS. 14 to 19 are diagrams illustrating examples in which the method of controlling the electronic device according to the third embodiment of this document is implemented;

FIG. 20 is a flowchart illustrating a method of controlling an electronic device according to a fourth embodiment of this document;

FIGS. 21 and 22 are diagrams illustrating examples in which the method of controlling the electronic device according to the fourth embodiment of this document is implemented;

FIG. 23 is a flowchart illustrating a method of controlling an electronic device according to a fifth embodiment of this document;

FIG. 24 is a diagram illustrating an example in which the method of controlling the electronic device according to the fifth embodiment of this document is implemented;

FIG. 25 is a flowchart illustrating a method of controlling an electronic device according to a sixth embodiment of this document;

FIGS. 26 and 27 are diagrams illustrating examples in which the method of controlling the electronic device according to the sixth embodiment of this document are implemented; and

FIGS. 28 to 30 are diagrams illustrating examples in which the plurality of regions is arranged in various ways.

### DETAILED DESCRIPTION

The above objects, characteristics, and merits of this document will become more apparent from the following detailed description taken in conjunction with the accompanying drawings. Some exemplary embodiments of this document are described in detail below with reference to the accompanying drawings. The same reference numerals designate the same elements throughout the drawings. Furthermore, detailed descriptions of the known functions or elements will be omitted if they are deemed to make the gist of this document unnecessarily vague.

Hereinafter, an electronic device related to this document is described in detail below with reference to the accompanying drawings. It is to be noted that the suffixes of constituent elements in the following description, such as “module” and “unit,” are assigned or mixed in use by taking only the easy of writing this document into consideration, but are not given special meanings or roles.

The electronic device described in this description may comprise a mobile phone, a smart phone, a laptop computer, a terminal for digital broadcasting, Personal Digital Assistants (PDA), a Portable Multimedia Player (PMP), a navigator, a Mobile Internet Device (MID), and so on.

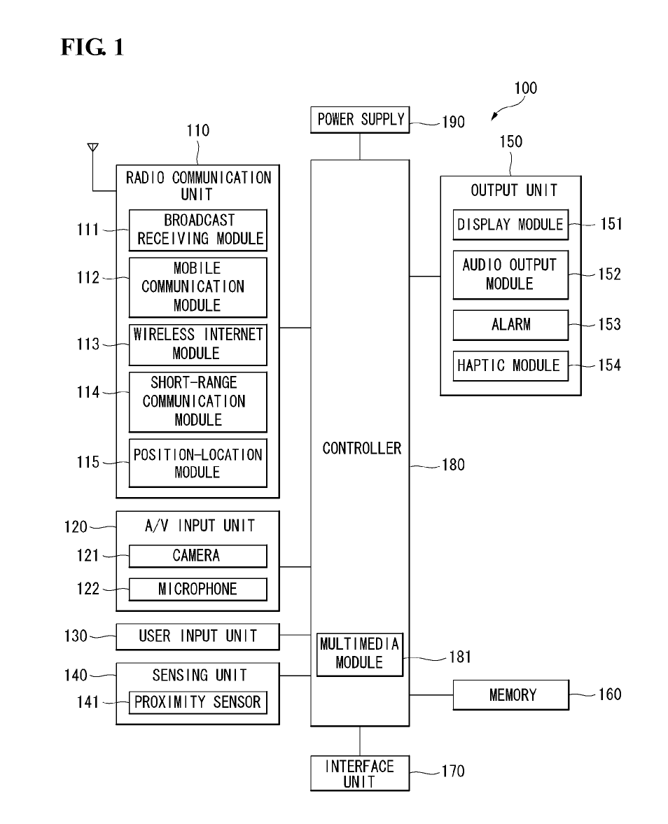

FIG. 1 is a block diagram of the electronic device which is related to an embodiment of this document.

The electronic device 100 comprises a wireless communication unit 110, an audio/video (A/V) input unit 120, a user input unit 130, a sensing unit 140, an output unit 150, memory 160, an interface unit 170, a controller 180, and a power supply 190. It is to be noted that the elements shown in FIG. 1 are not indispensable and the electronic device may comprise larger or fewer elements than the above-described elements.

Hereinafter, the elements are described in detail.

The wireless communication unit 110 may comprise one or more modules which permit wireless communication between the mobile electronic device 100 and a wireless communication system or a network within which the mobile electronic device 100 is located. The wireless communication unit 110 may comprise, for example, a broadcast receiving module 111, a mobile communication module 112, a wireless Internet module 113, a short-range communication module 114 and a position-location module 115.

The broadcast receiving module 111 may receive a broadcast signal or broadcast associated information or both from an external broadcast managing entity via a broadcast channel.

The broadcast channel may comprise a satellite channel and a terrestrial channel. The broadcasting managing entity may be a server for generating and sending broadcast signals or broadcast associated information or both or a server for receiving previously generated broadcast signals or broadcast associated information or both and sending the broadcast signals or the broadcast associated information or both to the electronic device. The broadcast signals may comprise not only TV broadcast signals, radio broadcast signals, and data broadcast signals, but also signals in the form of a combination of a TV broadcast signal or a radio broadcast signal and a data broadcast signal.

The broadcast associated information may be information about a broadcasting channel, a broadcasting program, or a broadcasting service provider. The broadcast associated information may be provided even over a mobile communication network. In the latter case, the broadcast associated information may be received by the mobile communication module 112.

The broadcast associated information may exist in various forms. For example, the broadcast associated information may exist in the form of an electronic program guide (EPG) of digital multimedia broadcasting (DMB) and an electronic service guide (ESG) of digital video broadcast-handheld (DVB-H).

The broadcast receiving module 111 may receive broadcast signals transmitted from various types of broadcast systems. As a non-limiting example, the broadcasting systems may receive digital broadcast signals using digital broadcast systems, such as digital multimedia broadcasting-terrestrial (DMB-T), digital multimedia broadcasting-satellite (DMB-S), media forward link only (MediaFLO®), digital video broadcast-handheld (DVB-H), and integrated services digital broadcast-terrestrial (ISDB-T). The broadcast receiving module 111 may be configured to be suitable for other broadcast systems, providing broadcast signals, in addition to the above digital broadcast systems.

The broadcast signals or the broadcast associated information or both which are received through the broadcast receiving module 111 may be stored in the memory 160.

The mobile communication module 112 sends and receives radio signals to and from at least one of a base station, an external terminal, and a server over a mobile communication network. The radio signals may comprise voice call signals, video telephony call signals, or data of various forms according to the transmission and reception of text and multimedia messages.

The wireless Internet module 113 refers to a module for wireless Internet access. The wireless Internet module 113 may be internally or externally coupled to the electronic device 100. Suitable technologies for wireless Internet may comprise, but are not limited to, WLAN (Wireless LAN) (Wi-Fi), Wibro (Wireless broadband), Wimax (World Interoperability for Microwave Access), or HSDPA (High Speed Downlink Packet Access) and so on.

The short-range communication module 114 may facilitate short-range communications. Suitable technologies for short-range communication may comprise, but are not limited to, radio frequency identification (RFID), infrared data association (IrDA), ultra-wideband (UWB), as well as networking technologies such as Bluetooth and ZigBee.

The position-location module 115 may identify or otherwise obtain a location of the electronic device 100. The position-location module 115 may obtain position information by using a global navigation satellite system (GNSS). The GNSS is a term used to describe radio navigation satellite systems configured to send reference signals capable of determining their positions on the surface of the earth or near the surface of the earth, while revolving the earth. The GNSS may comprise a global position system (GPS) operated by U.S.A, Galileo operated by Europe, a global orbiting navigational satellite system (GLONASS) operated by Russia, COMPASS operated by China, a quasi-zenith satellite system (QZSS) operated by Japan, and so on.

As a typical example of the GNSS, the position-location module 115 may be a GPS (Global Position System) module. The GPS module 115 may calculate information about distances between one point (or object) and at least three satellites and information about the time when the distance information was measured and apply trigonometry to the obtained distance information to obtain three-dimensional position information on the point (or object) according to the latitude, longitude, and altitude at a predetermined time. Furthermore, a method of calculating position and time information using three satellites and correcting the calculated position and time information using another satellite may also used. The GPS module 115 continues to calculate a current position in real time and velocity information on the basis of the position information.

Referring to FIG. 1, the A/V input unit 120 may provide audio or video signal input to the electronic device 100. The A/V input unit 120 may comprise a camera 121 and a microphone 122. The camera 121 processes image frames of still images or moving images obtained by an image sensor in a video telephony mode or a photographing mode. The processed image frames may be displayed on a display module 151.

The image frames processed by the camera 121 may be stored in the memory 160 or sent to an external device through the wireless communication unit 110. The electronic device 100 may comprise two or more cameras 121, if appropriate.

The microphone 122 may receive an external audio signal while the electronic device is in a particular mode, such as a phone call mode, a recording mode or a voice recognition mode. The received audio signal may then be processed and converted into electrical audio data. In the call mode, the processed audio data may be converted into a form which may be transmitted to a mobile communication base station through the mobile communication module 112 and then output. The electronic device 100, and in particular the A/V input unit 120, may comprise a noise removing algorithm (or noise canceling algorithm) for removing noise generated in the course of receiving the external audio signal.

The user input unit 130 may generate input data responsive to user manipulation of an associated input device or devices. Examples of such devices may comprise a keypad, a dome switch, a touchpad (for example, static pressure/capacitance), a jog wheel, and a jog switch.

The sensing unit 140 may provide status measurements of various aspects of the electronic device 100. For example, the sensing unit 140 may detect an open/close status (or state) of the electronic device 100, a position of the electronic device 100, a presence or absence of user contact with the electronic device 100, an orientation of the electronic device 100, or acceleration/deceleration of the electronic device 100 and generate a sense signal for controlling the operation of the electronic device 100. The electronic device 100 may be configured as a slide-type electronic device. In such a configuration, the sensing unit 140 may sense whether a sliding portion of the electronic device 100 is open or closed. The sensing unit 140 may also sense the presence or absence of power provided by the power supply 190, the presence or absence of a coupling or other connection between the interface unit 170 and an external device. Meanwhile, the sensing unit 140 may comprise a proximity sensor 141.

The output unit 150 may generate an output relevant to a sight sense, an auditory sense, or a tactile sense. The output unit 150 may comprise a display module 151, an audio output module 152, an alarm 153, and a haptic module 154.

The display module 151 may display (or output) information processed by the electronic device 100. For example, in case that the electronic device 100 is in the call mode, the display module 151 may display a user interface (UI) or a graphic user interface (GUI) associated with the call. If the electronic device 100 is in the video telephony mode or the photographing mode, the display module 151 may display a photographed or received image, a UI, or a GUI.

The display module 151 may comprise at least one of a liquid crystal display (LCD), a thin film transistor liquid crystal display (TFT LCD), an organic light-emitting diode (OLED), a flexible display, and a 3-dimensional display.

The display module 151 may have a transparent or light-transmittive type configuration to enable an external environment to be seen therethrough. This may be called a transparent display. A transparent LCD may be an example of the transparent display. A backside structure of the display module 151 may also have the light-transmittive type configuration. In this configuration, a user may see an object located behind the body of the electronic device through the area occupied by the display module 151 of the body.

At least two display modules 151 may be provided according to the electronic device 100. For example, a plurality of displays may be provided on a single face of the electronic device 100 by being built in one body or spaced apart from the single face. Alternatively, each of a plurality of displays may be provided on different faces of the electronic device 100.

If the display module 151 and a sensor for detecting a touch action (hereafter referred to as a ‘touch sensor’) are constructed in a mutual-layered structure (hereafter referred to as a ‘touch screen’), the display module 151 may be used as an input device as well as an output device. For example, the touch sensor may comprise a touch film, a touch sheet, and a touchpad.

The touch sensor may convert a pressure applied to a specific portion of the display module 151 or a variation of electrostatic capacity generated from a specific portion of the display module 151 to an electric input signal. The touch sensor may detect a pressure of a touch as well as a position and size of the touch.

If a touch input is provided to the touch sensor, signal(s) corresponding to the touch input may be transferred to a touch controller. The touch controller may process the signal(s) and then transfer corresponding data to the controller 180. The controller 180 may therefore know which portion of the display module 151 is touched.

Referring to FIG. 1, the proximity sensor 141 can be provided within the electronic device 100 enclosed by the touch screen or around the touch screen. The proximity sensor 141 may detect a presence or non-presence of an object approaching a prescribed detecting surface or an object existing around the proximity sensor 141 using an electromagnetic field strength or infrared ray without mechanical contact. The proximity sensor 141 may have a longer durability than the contact type sensor and may also have a greater usage than the contact type sensor.

The proximity sensor 141 may comprise, for example, a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, and an infrared proximity sensor.

If the touch screen is an electrostatic type, the proximity sensor 141 may detect proximity of a pointer using a variation of an electric field according to the proximity of the pointer. In this case, the touch screen (or touch sensor) may be classified as the proximity sensor.

An action in which a pointer approaches the touch screen without contacting the touch screen may be called a ‘proximity touch’. An action in which a pointer actually touches the touch screen may be called a ‘contact touch’. The location of the touch screen proximity-touched by the pointer may be the position of the pointer that vertically opposes the touch screen when the pointer performs the proximity touch.

The proximity sensor 141 may detect a proximity touch or a proximity touch pattern or both (for example, a proximity touch distance, a proximity touch duration, a proximity touch position, or a proximity touch shift state). Information corresponding to the detected proximity touch action or the detected proximity touch pattern or both may be outputted to the touch screen.

The audio output module 152 may output audio data that is received from the wireless communication unit 110 in a call signal reception mode, a call mode, a recording mode, a voice recognition mode, or a broadcast receiving mode. The audio output module 152 may output audio data stored in the memory 160. The audio output module 152 may output an audio signal relevant to a function (for example, a call signal receiving sound or a message receiving sound) performed by the electronic device 100. The audio output module 152 may comprise a receiver, a speaker, and a buzzer. The audio output module 152 may output audio through an earphone jack. A user may connect an earphone to the earphone jack and listen to the audio.

The alarm 153 may output a signal for informing an event generation of the electronic device 100. An event occurring in the electronic device 100 may comprise, for example, call signal reception, message reception, key signal input, and touch input. The alarm 153 may output a signal for informing an event generation by way of vibration as well as a video signal or an audio signal. The video or audio signal may be outputted via the display module 151 or the audio output module 152.

The haptic module 154 may bring about various haptic effects that can be sensed by a user. Vibration is a representative example for the haptic effect brought about by the haptic module 154. Strength and patterns of the vibration generated from the haptic module 154 may be controllable. For example, vibrations differing from each other may be outputted in a manner of being synthesized together or may be sequentially outputted.

The haptic module 154 may generate various haptic effects, such as an effect caused by such a stimulus as a pin array vertically moving against a contact skin surface, the jet power of air via outlet, a suction power of air via inlet, a skim on a skin surface, a contact of an electrode, and an electrostatic power, or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger or an arm. Two or more haptic modules 154 may be provided according to a configuration of the electronic device 100.

The memory 160 may store a program for the operations of the controller 180. The memory 160 may temporarily store input/output data (for example, phonebook, message, still picture, and moving picture). The memory 160 may store data of vibration and sound in various patterns outputted in case of a touch input to the touch screen.

The memory 160 may comprise at least one of flash memory, a hard disk, multimedia card micro type memory, card type memory (for example, SD or XD memory), random access memory (RAM), static random access memory (SRAM), read-only memory (ROM), electrically erasable programmable read-only memory, programmable read-only memory, magnetic memory, a magnetic disk, and an optical disk. The electronic device 100 may operate in association with a web storage that performs a storage function of the memory 160 on the Internet.

The interface unit 170 may play a role as a passage to external devices connected to the electronic device 100. The interface unit 170 may receive data from the external devices. The interface unit 170 may be supplied with power and then the power may be delivered to elements within the electronic device 100. The interface unit 170 may enable data to be transferred to external devices from the inside of the electronic device 100. The interface unit 170 may comprise a wire/wireless headset port, an external charger port, a wire/wireless data port, a memory card port, a port for coupling to a device having an identity module, an audio input/output (I/O) port, a video input/output (I/O) port, an earphone port and the like.

The identity module may be a chip or card that stores various kinds of information for authenticating the use of the electronic device 100. The identify module may comprise a user identity module (UIM), a subscriber identity module (SIM), or a universal subscriber identity module (USIM). A device provided with the above identity module (hereafter referred to as an ‘identity device’) may be manufactured in the form of a smart card. The identity device may be connected to the electronic device 100 via the port.

The interface unit 170 may play a role as a passage for supplying power to the electronic device 100 from a cradle connected to the electronic device 100. The interface unit 170 may play a role as a passage for delivering various command signals, which are inputted from the cradle by a user, to the electronic device 100. Various command signals inputted from the cradle or the power may work as a signal for recognizing that the electronic device 100 is correctly loaded onto the cradle.

The controller 180 may control the general operations of the electronic device 100. For example, the controller 180 may perform control and processing relevant to a voice call, data communication, a video telephony and so on. The controller 180 may comprise a multimedia module 181 for playing multimedia. The multimedia module 181 may be implemented within the controller 180 or may be configured separately from the controller 180.

The controller 180 may perform pattern recognizing processing for recognizing a handwriting input performed on the touch screen as a character or recognizing a picture drawing input performed on the touch screen as an image.

The power supply 190 may receive external or internal power and then supply the power for the operations of the elements under control of the controller 180.

Various embodiments of this document described in the following description may be implemented in a recording medium that can be read by a computer or a computer-like device using software, hardware, or a combination of them.

According to hardware implementations, the embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electrical units for performing other functions. In some cases, the embodiments may be implemented by the controller 180.

According to software implementations, embodiments, such as procedures or functions, may be implemented with separate software modules each of which may perform one or more of the functions and operations. Software codes may be implemented by a software application written in any suitable programming language. The software codes may be stored in memory, such as the memory 160, and executed by the controller 180.

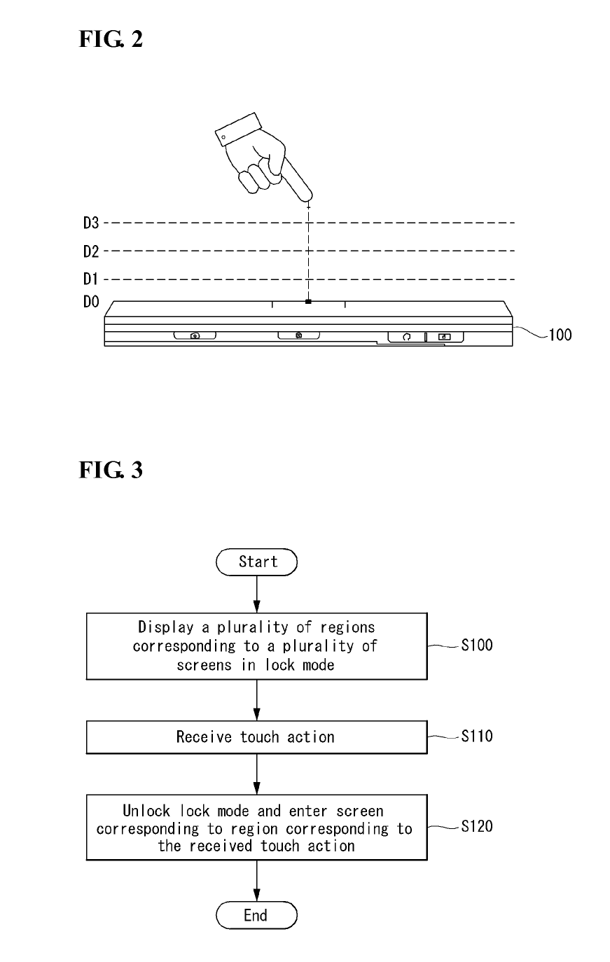

FIG. 2 is a conceptual diagram illustrating the proximity depth of the proximity sensor.

As shown in FIG. 2, when a pointer, such as a user's finger, a pen, or a stylus, approaches the touch screen, the proximity sensor 141 provided within or in the vicinity of the touch screen may detect the approach of the pointer and then output a proximity signal.

The proximity sensor 141 may output a different proximity signal according to the distance between the pointer and the proximity-touched touch screen (hereafter referred to as a ‘proximity depth’).

A distance from which a proximity signal is outputted when a point approaches the touch screen, is called a detection distance. The proximity depth can be known by comparing proximity signals outputted from proximity sensors with different detection distances.

FIG. 2 is a cross-sectional view of the touch screen provided with a proximity sensor capable of detecting three proximity depths, for example. A proximity sensor that identifies less than 3 proximity depths or more than 4 proximity depths may also be provided.

If the pointer fully contacts the touch screen (d0), it may be recognized as a contact touch. If the pointer is spaced apart from the touch screen by a distance less than d1, it may be recognized as a proximity touch to a first proximity depth. If the pointer is spaced apart from the touch screen by a distance equal to or greater than d1 and less than d2, it may be recognized as a proximity touch to a second proximity depth. If the pointer is spaced apart from the touch screen in a distance equal to or greater than d2 and less than d3, it may be recognized as a proximity touch to a third proximity depth. If the pointer is spaced apart from the touch screen in a distance equal to or greater than d3, a proximity touch is released.

The controller 180 may recognize the proximity touch as one of various input signals according to the proximity depth and position of the pointer. The controller 180 may control various operations according to various input signals.

Hereinafter, some exemplary embodiments of this document are described. In this document, it is assumed that the display module 151 is a touch screen 151, for convenience of description. As described above, the touch screen 151 may perform both functions of displaying and inputting information. It is however to be noted that this document is not limited thereto. Furthermore, touch described in this document may comprise both the contact touch and the proximity touch.

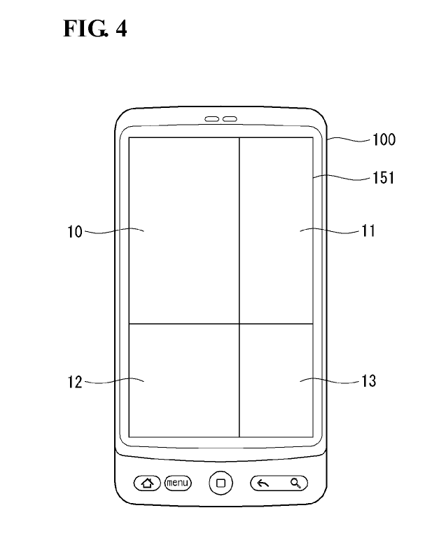

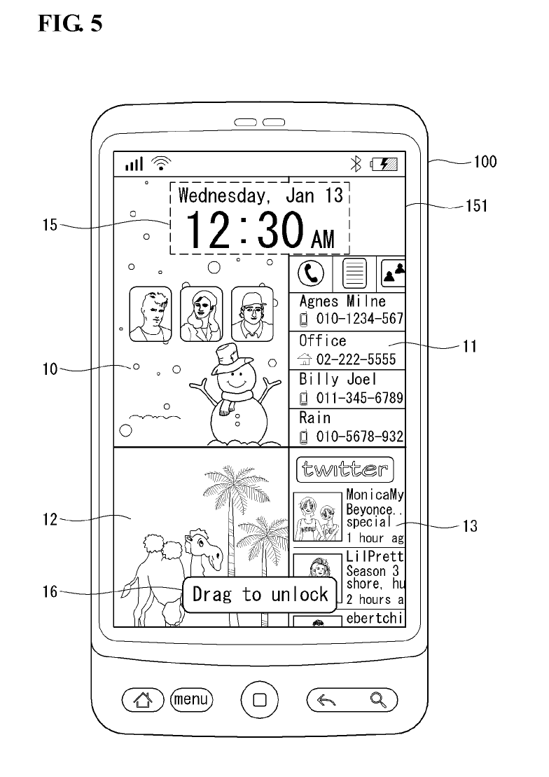

FIG. 3 is a flowchart illustrating a method of controlling an electronic device according to a first embodiment of this document, and FIGS. 4 and 5 are diagrams illustrating examples in which a plurality of regions is provided in the lock mode according to a first embodiment of this document.

The method of controlling an electronic device according to the first embodiment of this document may be implemented in the electronic device 100 described with reference to FIGS. 1 and 2. The method of controlling the electronic device according to the first embodiment of this document and the operations of the electronic device 100 for implementing the method are described in detail with reference to the relevant drawings.

Referring to FIG. 3, in case where the electronic device 100 is in a lock mode, the controller 180 may display a plurality of regions, corresponding to a plurality of screens, in the touch screen 151 at the same time at step S100.

In case where the electronic device 100 is in the lock mode, a user is unable to input information through the electronic device 100.

The lock mode of the electronic device 100 may be classified into two kinds.

The first lock mode corresponds to a case where the supply of power to the touch screen 151 is blocked and no information is provided through the touch screen 151.

The second lock mode corresponds to a case where power is supplied to the touch screen 151, and so specific information may be provided through the touch screen 151 and the lock mode may be unlocked by a manipulation for the touch screen 151 or other predetermined manipulation.

The first lock mode may be switched to the second lock mode or may be unlocked by a predetermined manipulation.

In this document, the lock mode of the electronic device 100 complies with commonly known technical characteristics in relation to the lock mode of a common electronic device, and a further description thereof is omitted. The technical spirit disclosed in this document, however, may assume the second lock mode in which power is supplied to the touch screen 151.

FIGS. 4 and 5 show examples in which the plurality of regions is provided to the touch screen 151 in the lock mode.

Referring to FIG. 4, the controller 180 may provide the plurality of regions 10, 11, 12, and 13, corresponding to respective screens, to the touch screen 151 in the lock mode in which power is supplied to the touch screen 151. Each of the plurality of screens corresponding to the respective regions 10, 11, 12, and 13 may be related to at least one application.

The controller 180 may display a screen, an icon or image, corresponding to each of the regions, in the corresponding region in order to inform that which screen corresponds to the region by taking the screen, corresponding to the region, into consideration.

Referring to FIG. 5, the controller 180 may display images, showing respective screens corresponding to the plurality of regions 10, 11, 12, and 13.

For example, an idle screen (or home screen) may correspond to the first region 10, and a communication screen may correspond to the second region 11.

The controller 180 may display a reduction image of the idle screen or an image, including some information of the idle screen, in the first region 10.

The communication screen refers to a screen which provides icons related to communication and various pieces of information related to communication. For example, the controller 180 may display a screen or image, related to at least one application pertinent to the transmission and reception of a call or a message, in the second region 11.

For another example, the controller 180 may display at least one of a list of received messages, a list of sent messages, a list of received calls, and a list of sent calls in the second region 11.

The second region 11 corresponding to the communication screen may display some items included in a contact book, such as a phonebook.

For example, a multimedia screen may correspond to the third region 12, and an e-mail/social network service (SNS) screen may correspond to the fourth region 13.

A multimedia application pertinent to the management and play of multimedia content, such as audio and video, may correspond to the multimedia screen.

For example, the controller 180 may display, in the third region 12, a screen executed by the multimedia application or an image pertinent to the execution screen.

For example, in case where the play of an audio file or a video file is paused, the controller 180 may display a captured image of corresponding content in the third region 12. In case where the play of multimedia content is completed or the play of multimedia content is not performed, the controller 180 may display a predetermined image or a representative image of content, most frequently accessed by a user, in the third region 12.

The e-mail/SNS screen is used to provide information related to e-mail and SNS. Furthermore, the e-mail/SNS screen may be related to an e-mail application, such as e-mail clients, and at least one SNS application.

For example, the controller 180 may display an image, including information related to the e-mail or the SNS, in the fourth region 13.

The controller 180 may differently control the sizes of the plurality of regions, provided in the lock mode. Here, the controller 180 may control the sizes of the regions according to predetermined criteria.

For example, the controller 180 may control a region corresponding to a screen, becoming a basis or set as the most important screen, so that the region has the largest size.

For another example, the controller 180 may differently control the sizes of the regions in order of frequency of use by users.

For another example, the controller 180 may differently control the sizes of the regions in order of most recently used.

The lock screen shown in FIG. 5 may comprise date/time information 15 and a guidance wording 16 for unlocking in addition to the plurality of regions 10, 11, 12, and 13.

Meanwhile, the plurality of screens corresponding to the plurality of regions provided in the touch screen 151 in the lock mode may comprise at least one of a screen previously set up by a user, a screen most recently executed, a screen related to an application having the highest frequency of use, and the idle screen.

The plurality of screens corresponding to the plurality of regions may consist of a combination of the screen previously set up by a user, the screen most recently executed, the screen having the highest frequency of use, and the idle screen.

For example, the plurality of screens corresponding to the plurality of regions may consist of only a plurality of the screens set up by a user or only a plurality of the idle screens (or home screens).

For another example, the plurality of screens corresponding to the plurality of regions may consist of a combination of the screen set up by a user, the screen most recently executed, and the idle screen.

The controller 180 may receive predetermined touch action through the touch screen 151 in the lock mode at step S110.

The controller 180 may not receive touch input through the touch screen 151 in the first lock mode, but may receive touch input through the touch screen 151 in the second lock mode.

When the touch action is received, the controller 180 may unlock the lock mode and enter a screen corresponding to a region corresponding to the received touch action, from among the plurality of regions, at step S120.

The predetermined touch action performed at step S110 and the execution of step S120 according to the reception of the touch action are described in detail later in conjunction with a variety of embodiments.

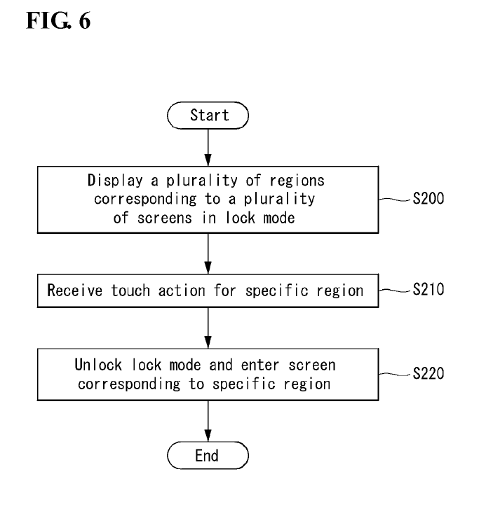

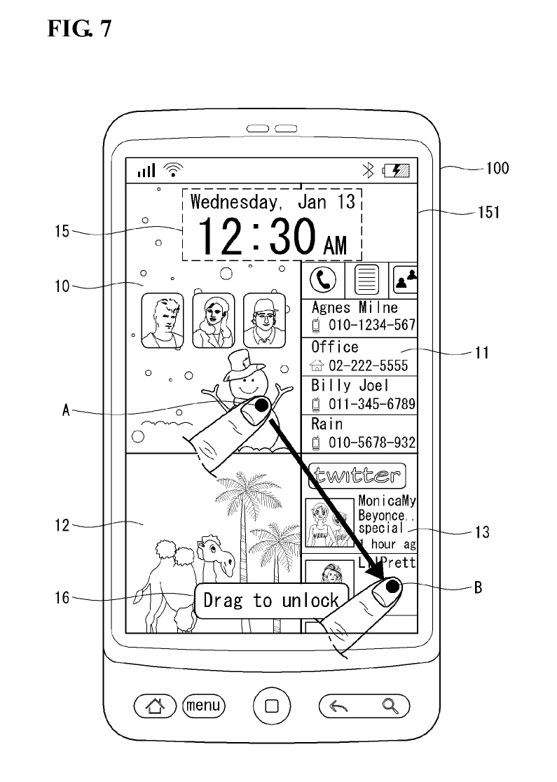

FIG. 6 is a flowchart illustrating a method of controlling an electronic device according to a second embodiment of this document, and FIGS. 7 to 12 are diagrams illustrating examples in which the method of controlling the electronic device according to the second embodiment of this document is implemented.

The method of controlling an electronic device according to the second embodiment of this document may be implemented in the electronic device 100 described with reference to FIGS. 1 and 2. The method of controlling the electronic device according to the second embodiment of this document and the operations of the electronic device 100 for implementing the method are described in detail with reference to the relevant drawings.

Referring to FIG. 6, in case where the electronic device 100 is in the lock mode, the controller 180 may display a plurality of regions, corresponding to a plurality of screens, in the touch screen 151 at the same time at step S200. The step S200 corresponds to the step S100 in the first embodiment of this document, and a further description thereof is omitted.

In case where a touch action for a specific one of the plurality of regions is received at step S210, the controller 180 may unlock the lock mode and enter a screen corresponding to the specific region at step S220.

The touch action for the specific region performed at step S210 may be a stroke action. The stroke action may comprise a drag action and a flicking action.

For example, referring to FIG. 7, a user may touch a point A included in the first region 10 and move the touch to a point B (corresponding to the drag action or the flicking action).

When a user touches a specific point of the first region 10 (that is, the point A in FIG. 7) and moves the touch, the controller 180 may control the first region 10 such that the first region 10 is moved while operating in conjunction with the touch movement.

When the first region 10 is moved, the controller 180 may control the second to fourth regions 11, 12, and 13 such that the second to the fourth regions 11, 12, and 13 are moved or not moved.

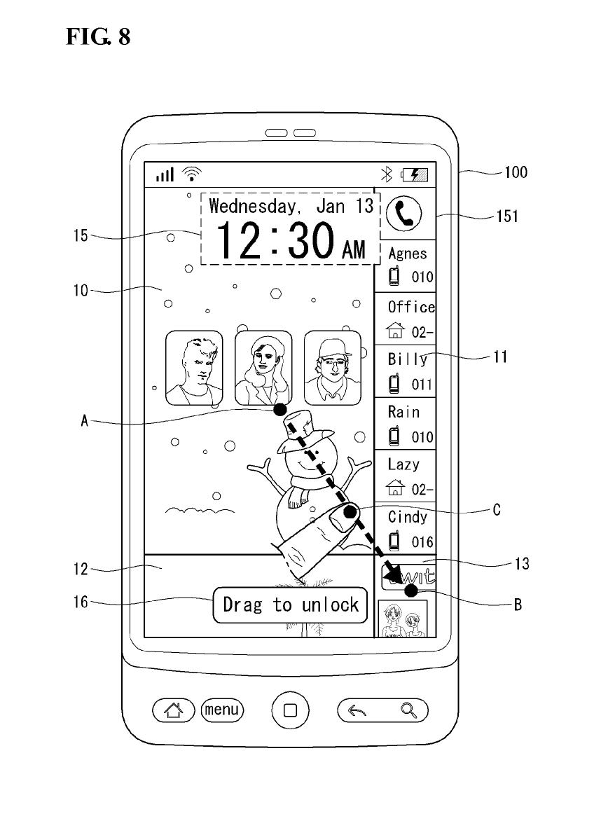

FIG. 8 is a diagram illustrating an example in which the first to fourth regions 10, 11, 12, and 13 are moved in response to the stroke action of a user performed in FIG. 7.

Referring to FIG. 8, in case where the user's touch movement (drag or flicking) reaches a point C, the controller 180 may control the first to fourth regions 10, 11, 12, and 13 such that they are moved together.

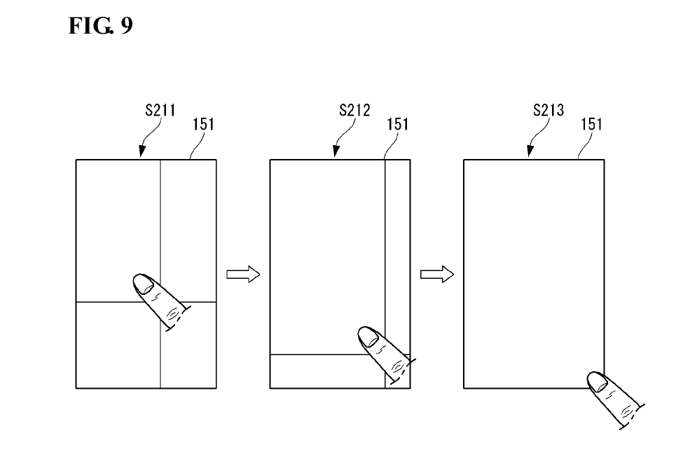

FIG. 9 is a diagram illustrating the movements of a specific region and the remaining regions in response to a user' stroke action for the specific region. That is, FIG. 9 shows an example in which the size of a specific region is increased in response to a user' stroke action for the specific region at step S211, S212, and S213.

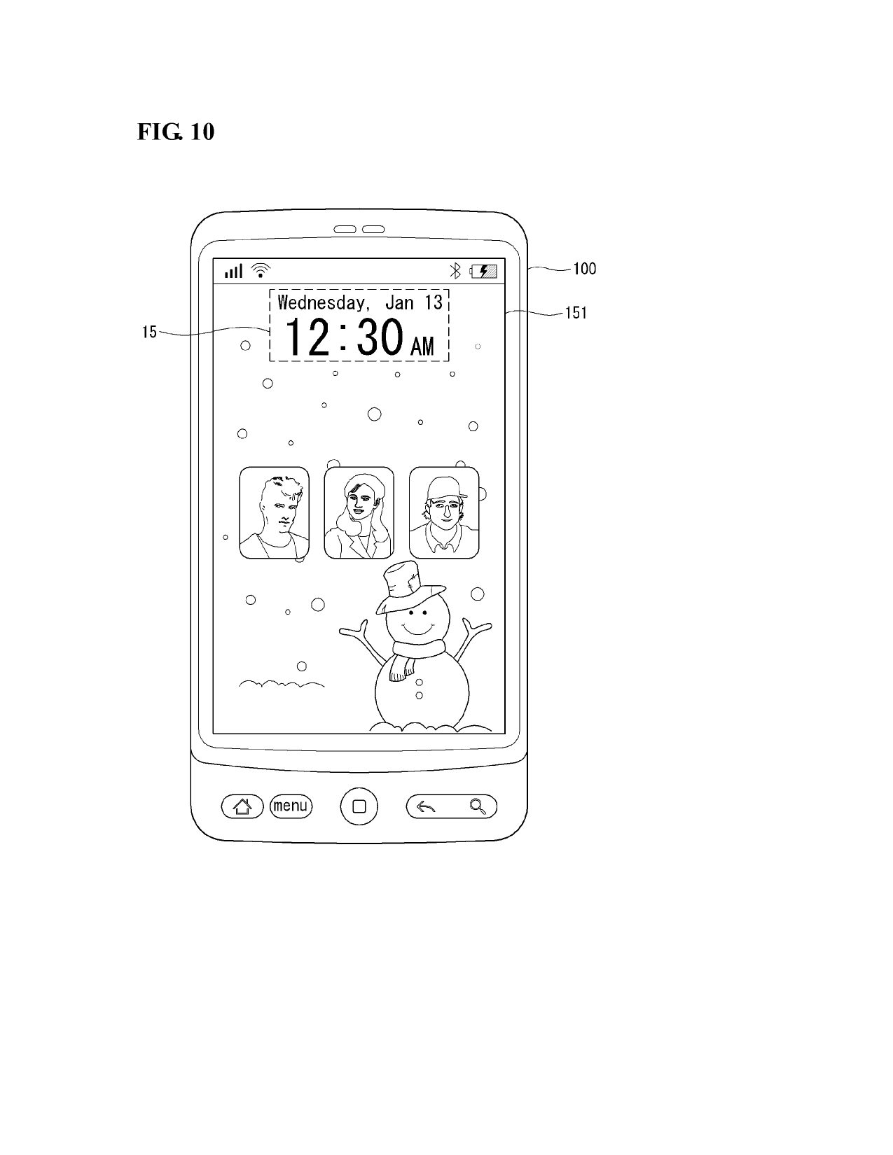

FIG. 10 is a diagram illustrating an example in which the step S220 is performed in response to the user' stroke action performed at step S210.

For example, referring to FIG. 10, when a user takes a stroke action as shown in FIG. 7, the controller 180 may unlock the lock mode and enter the idle screen (that is, a screen corresponding to the first region 10).

Meanwhile, only in case where the stroke action for the specific region is taken so that it satisfies at least one of a predetermined direction and a predetermined distance, the controller 180 may unlock the lock mode and enter a screen corresponding to the specific region.

For example, referring to FIGS. 7 and 8, in case where a user' stroke action is taken from the point A to the point B, the controller 180 may perform the unlock operation of the lock mode and the operation of entering the idle screen corresponding to the first region 10.

In the state in which the user' stroke action has been taken from the point A to the point C in FIGS. 7 and 8, the controller 180 may not perform the unlock operation of the lock mode and the operation of entering the idle screen corresponding to the first region 10.

For example, the controller 180 may not take the direction of a stroke action, taken by a user, into consideration. For example, in case where a user moves a touch started at the first region 10 by a distance from the point A to the point B in FIGS. 7 and 8, the controller 180 may perform the unlock operation of the lock mode and the operation of entering the idle screen if the touch movement satisfies only the distance irrespective of the direction of the touch movement.

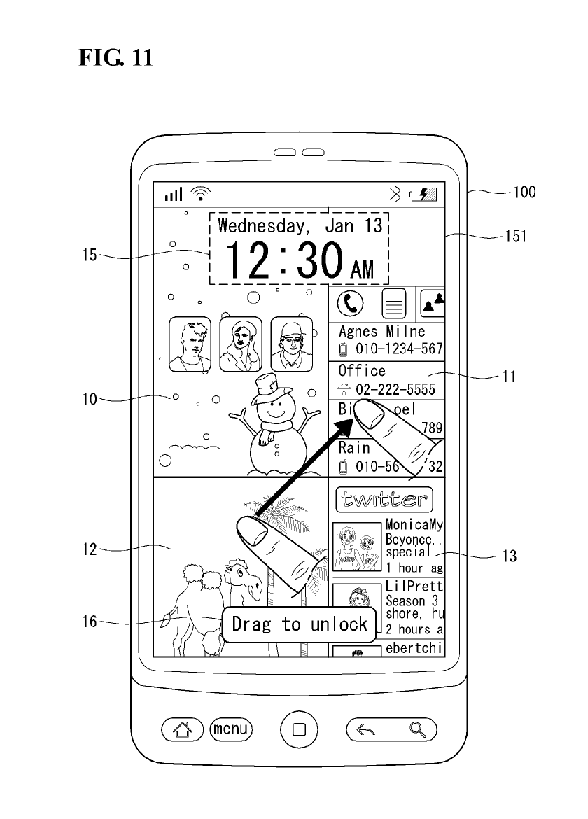

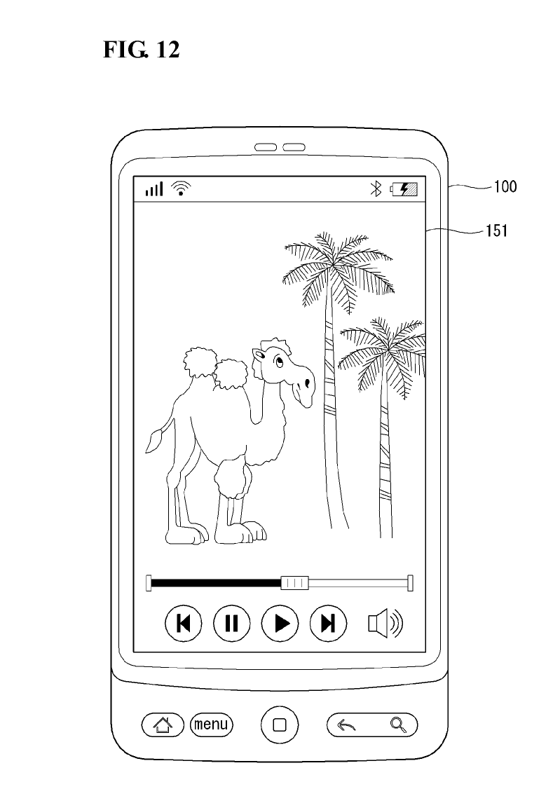

FIGS. 11 and 12 show another example in which the steps S210 and S220 are performed.

When a user takes a stroke action for the third region 12 in the direction in which the size of the third region 12 is enlarged as shown in FIG. 11, the controller 180 may unlock the lock mode and enter a multimedia screen (that is, a screen corresponding to the third region 12).

Meanwhile, as shown in FIGS. 10 and 12, a screen entered after the lock mode is unlocked at step S220 needs not to be necessarily the same as an image displayed in the lock mode before the step S220 is performed.

For example, an image displayed in each of the plurality of regions 10, 11, 12, and 13 in the lock mode in which the plurality of regions 10, 11, 12, and 13 is provided to the touch screen 151 needs not to be fully identical with a screen entered at step S220 because it is a screen for making a user recognize a screen corresponding to each region.

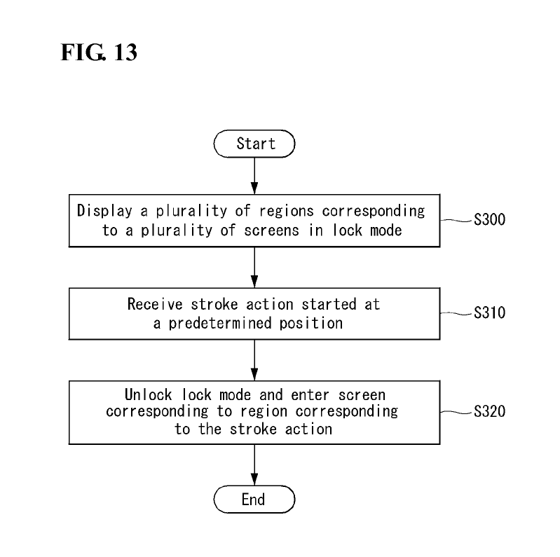

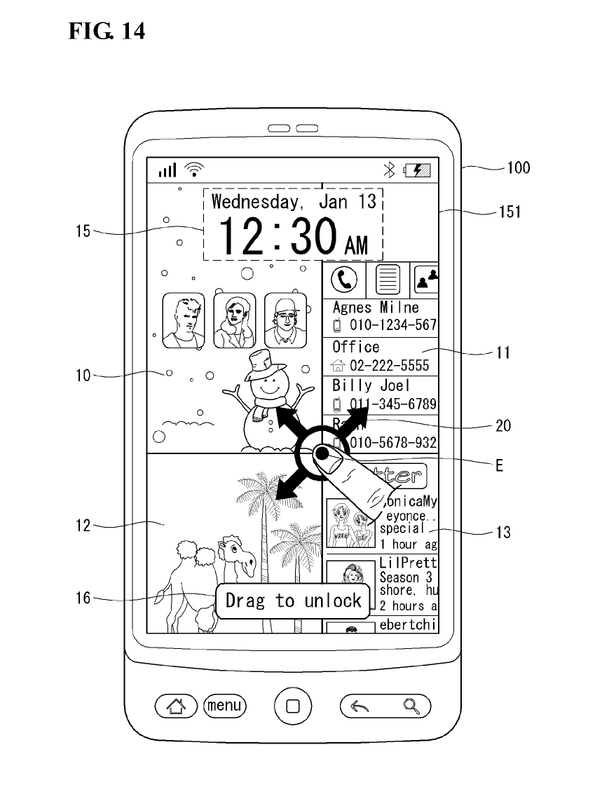

FIG. 13 is a flowchart illustrating a method of controlling an electronic device according to a third embodiment of this document, and FIGS. 14 to 19 are diagrams illustrating examples in which the method of controlling the electronic device according to the third embodiment of this document is implemented.

The method of controlling an electronic device according to the third embodiment of this document may be implemented in the electronic device 100 described with reference to FIGS. 1 and 2. The method of controlling the electronic device according to the third embodiment of this document and the operations of the electronic device 100 for implementing the method are described in detail with reference to the relevant drawings.

Referring to FIG. 13, in case where the electronic device 100 is in the lock mode, the controller 180 may display a plurality of regions, corresponding to a plurality of screens, in the touch screen 151 at the same time at step S300. The step S300 corresponds to the step S100 in the first embodiment of this document, and a further description thereof is omitted.

In case where a stroke action started at predetermined position on the touch screen 151 is received at step S310, the controller 180 may unlock the lock mode and enter a screen corresponding to a region corresponding to the stroke action, from among the plurality of regions at step S320.

The predetermined position on the touch screen 151 may be various.

For example, the predetermined position may be a point where all the plurality of regions adjoins. For another example, the predetermined position may be a specific region including a point where all the plurality of regions adjoins.

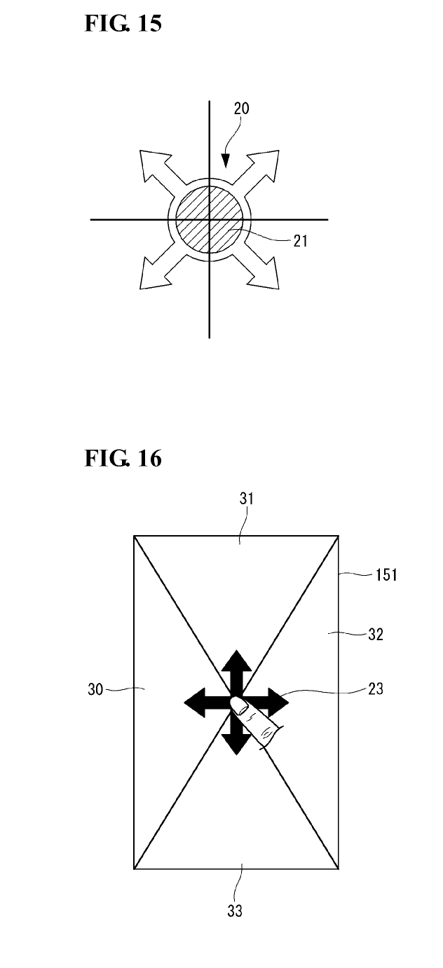

FIGS. 14 and 15 show examples illustrating the predetermined position in relation to the step S310.

Referring to FIG. 14, the predetermined position may be a point E where all the first to fourth regions 10, 11, 12, and 13 adjoin.

In case where a user touches the predetermined position, the controller 180 may display, in the touch screen 151, an indicator showing at least one direction where the stroke action (that is, a requirement for executing the step S320) may be taken.

For example, referring to FIG. 14, when a user touches the point E, an indicator 20 for showing a direction may be displayed so that it corresponds to the point E.

Meanwhile, the predetermined position, as described above, may be a specific region. For example, referring to FIG. 15, a specific region 21 including the point E may be the predetermined position.

That is, in case where a user touches the specific region 21, the controller 180 may display the indicator 20 in the touch screen 151 so that the indicator 20 corresponds to the point E and make preparations for the execution of the step S320.

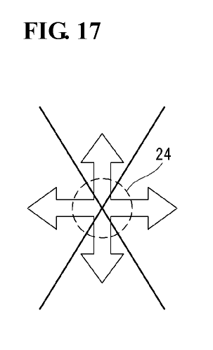

FIGS. 16 and 17 show another example illustrating the predetermined position in relation to the step S310.

For example, referring to FIG. 16, in case where a point (that is, the predetermined position) where all the plurality of regions 30, 31, 32, and 33 adjoins is touched, the controller 180 may display, in the touch screen 151, an indicator 23 for showing a direction of the stroke action.

For another example, referring to FIG. 17, the predetermined position may be a specific region 24 including the point where all the plurality of regions 30, 31, 32, and 33 adjoins.

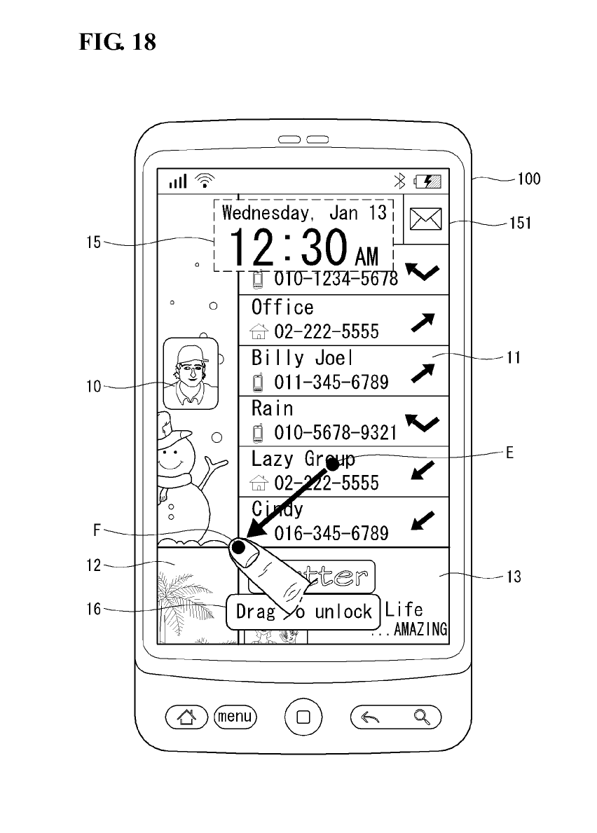

FIG. 18 is a diagram illustrating an example in which a touch for the predetermined position (that is, point E) of FIG. 14 is moved.

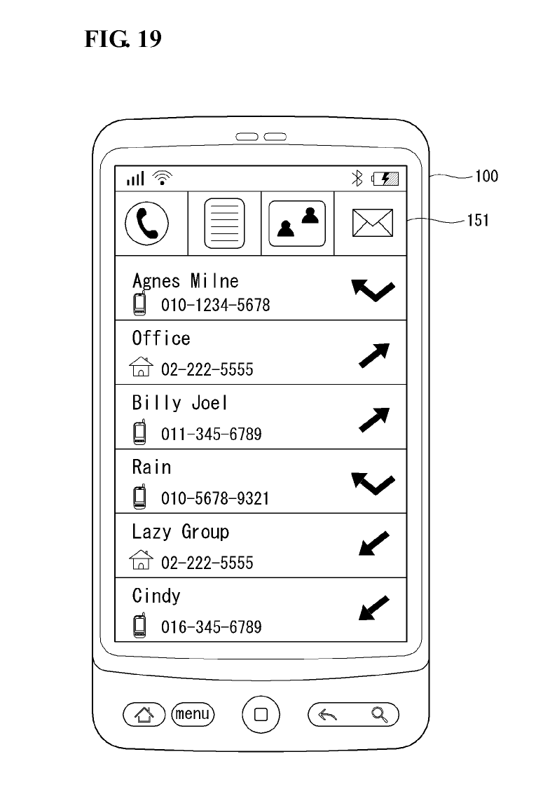

In case where a touch started at the predetermined position is moved as shown in FIG. 18, the controller 180 may enter a screen corresponding to a region corresponding to the movement of the touch as shown in FIG. 19.

Here, the controller 180 may enter a screen corresponding to a region which exists on the other side to the direction of the stroke action, from among the plurality of regions. It may also be considered that the controller 180 enters a screen corresponding to a region whose size is enlarged in response to the stroke action.

For example, referring to FIGS. 14 and 18, when a user touches the point E and moves the touch to the third region 12 (that is, an opposite direction to the direction where the second region 11 exists), the controller 180 may enter a communication screen (that is, a screen corresponding to the second region 11).

That is, the controller 180 has to determine any one of the plurality of regions, provided in the lock mode, in order to perform the step S320. Here, the controller 180 may determine any one of the plurality of regions with consideration taken of at least one of the direction and distance of the stroke action started at the predetermined position and enter a screen corresponding to the determined region.

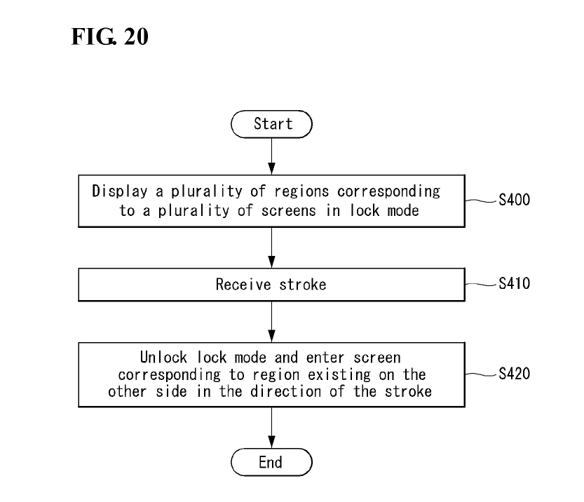

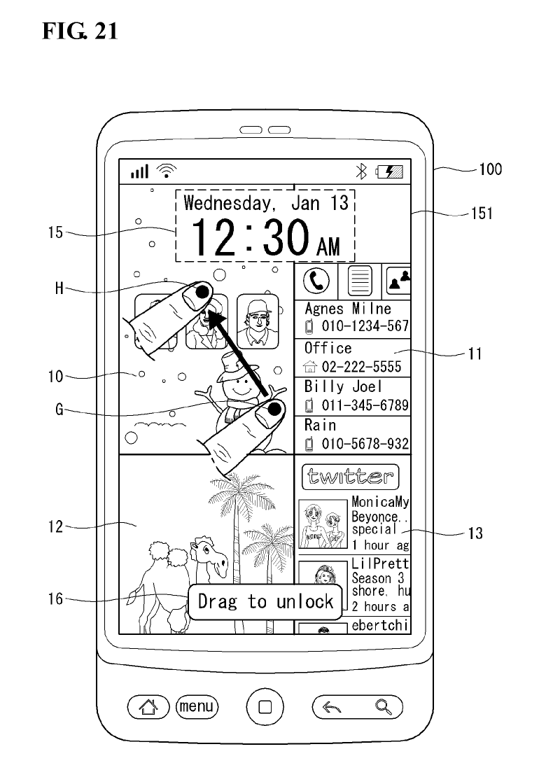

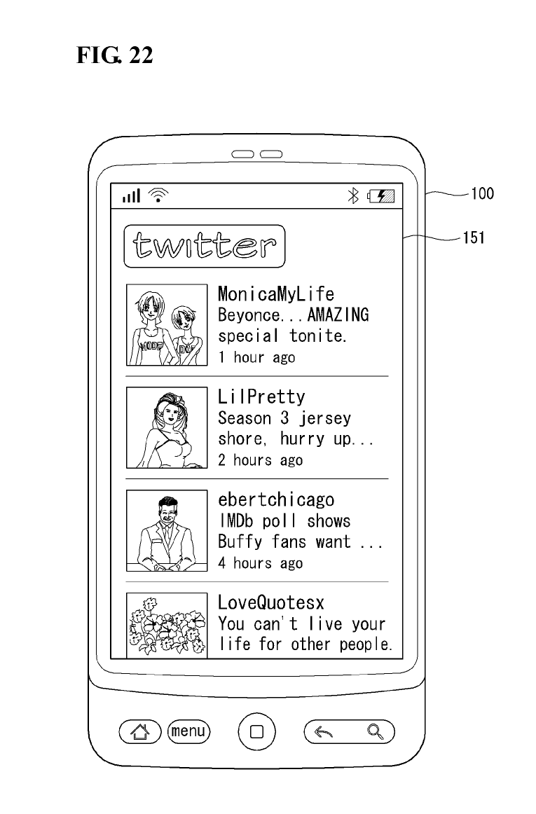

FIG. 20 is a flowchart illustrating a method of controlling an electronic device according to a fourth embodiment of this document, and FIGS. 21 and 22 are diagrams illustrating examples in which the method of controlling the electronic device according to the fourth embodiment of this document is implemented.

The method of controlling an electronic device according to the fourth embodiment of this document may be implemented in the electronic device 100 described with reference to FIGS. 1 and 2. The method of controlling the electronic device according to the fourth embodiment of this document and the operations of the electronic device 100 for implementing the method are described in detail with reference to the relevant drawings.

Referring to FIG. 20, in case where the electronic device 100 is in the lock mode, the controller 180 may display a plurality of regions, corresponding to a plurality of screens, in the touch screen 151 at the same time at step S400. The step S400 corresponds to the step S100 in the first embodiment of this document, and a further description thereof is omitted.

In case where a stroke is received through the touch screen 151 in the lock mode at step S410, the controller 180 may enter a screen corresponding to a region which exists on the opposite side to the direction where the stroke is performed, from among the plurality of regions, at step S420.

In the fourth embodiment of this document, unlike the second embodiment of this document, a user does not necessarily touch a region corresponding to a region that the user will enter.

That is, according to the fourth embodiment of this document, the controller 180 may determine a region corresponding to a screen that will be entered, from among the plurality of regions, by taking only the direction of a stroke action taken by a user into consideration.

For example, referring to FIG. 21, a user may take a stroke (the movement of a touch from a point G to a point H) in the opposite direction of the fourth region 13 in order to access a screen corresponding to the fourth region 13.

When the user' stroke action is taken in FIG. 21, the controller 180 may enter an e-mail/SNS screen (that is, a screen corresponding to the fourth region 13), as shown in FIG. 22.

Referring to FIGS. 21 and 22, although the stroke action is performed in the first region 10 as described above, the controller 180 may enter the screen corresponding to the fourth region 13.

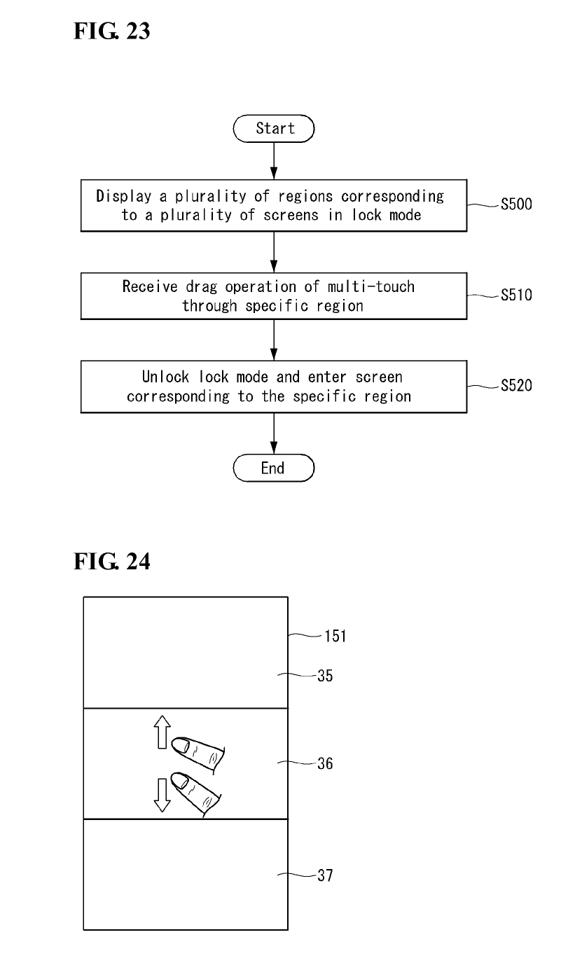

FIG. 23 is a flowchart illustrating a method of controlling an electronic device according to a fifth embodiment of this document, and FIG. 24 is a diagram illustrating an example in which the method of controlling the electronic device according to the fifth embodiment of this document is implemented.

The method of controlling an electronic device according to the fifth embodiment of this document may be implemented in the electronic device 100 described with reference to FIGS. 1 and 2. The method of controlling the electronic device according to the fifth embodiment of this document and the operations of the electronic device 100 for implementing the method are described in detail with reference to the relevant drawings.

Referring to FIG. 23, in case where the electronic device 100 is in the lock mode, the controller 180 may display a plurality of regions, corresponding to a plurality of screens, in the touch screen 151 at the same time at step S500. The step S500 corresponds to the step S100 in the first embodiment of this document, and a further description thereof is omitted.

In case where an operation of dragging a multi-touch is received through a specific one of the plurality of regions at step S510, the controller 180 may unlock the lock mode and enter a screen corresponding to the specific region at step S520.

For example, referring to FIG. 24, a user may simultaneously touch two points, included in a region 36 corresponding to a screen to be accessed, from among the plurality of regions 35, 36, and 37 and then perform an operation of widening the touch.

When the multi-touch drag action shown in FIG. 24 is received, the controller 180 may enter a screen (not shown) corresponding to the region 36.

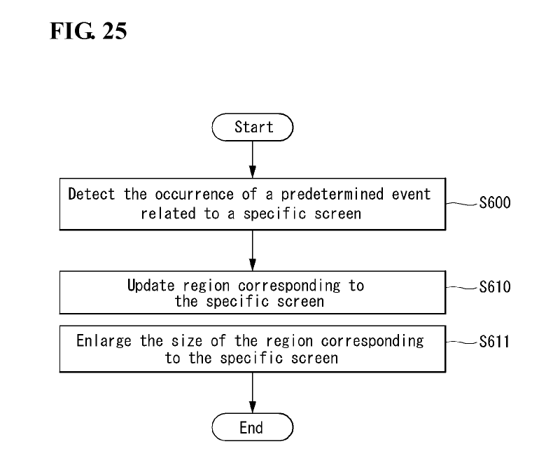

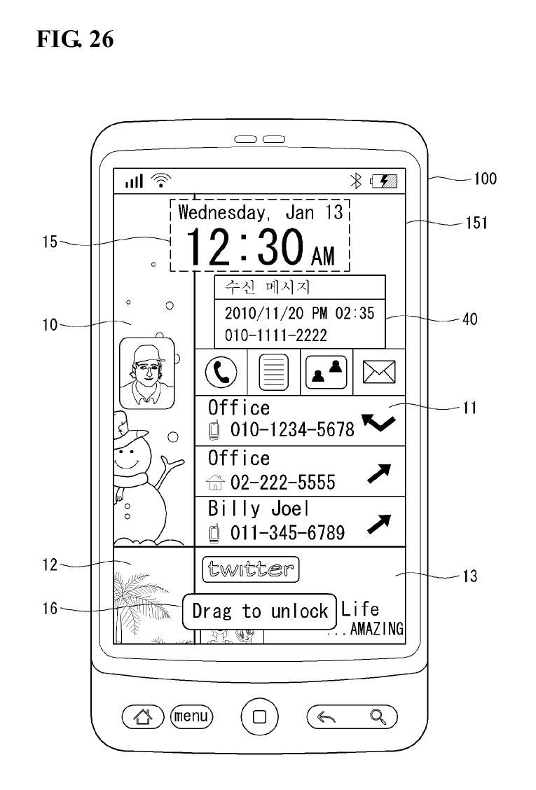

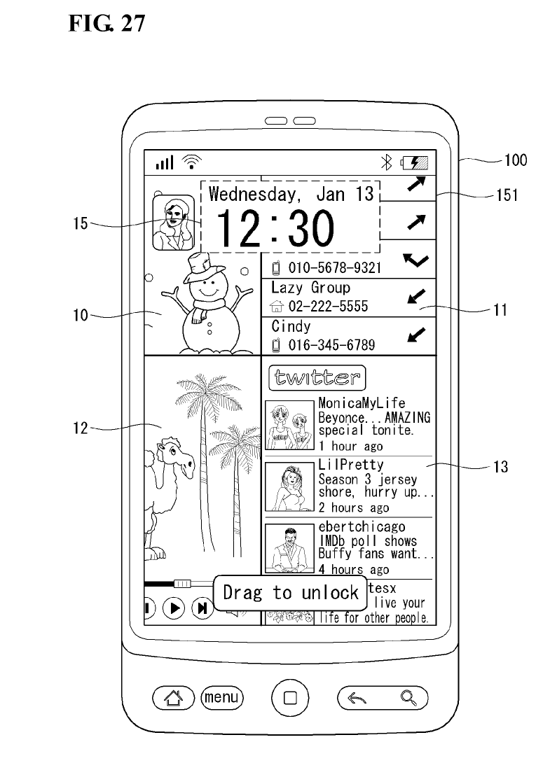

FIG. 25 is a flowchart illustrating a method of controlling an electronic device according to a sixth embodiment of this document, and FIGS. 26 and 27 are diagrams illustrating examples in which the method of controlling the electronic device according to the sixth embodiment of this document is implemented.

The method of controlling an electronic device according to the sixth embodiment of this document may be implemented in the electronic device 100 described with reference to FIGS. 1 and 2. The method of controlling the electronic device according to the sixth embodiment of this document and the operations of the electronic device 100 for implementing the method are described in detail with reference to the relevant drawings.

The method of controlling the electronic device according to the sixth embodiment of this document may be performed using the step S100 of the first embodiment of this document as a precondition. That is, it may be assumed that in case where the electronic device 100 is in the lock mode, a plurality of regions corresponding to a plurality of screens is being displayed in the touch screen 151 at the same time.

Furthermore, the method of controlling the electronic device according to the sixth embodiment of this document may also be applied to the second to fifth embodiments of this document. In other words, in case where the steps S100, S200, S300, S400, and S500 are performed, the method of controlling the electronic device according to the sixth embodiment of this document may be applied.

Referring to FIG. 25, in the state in which the plurality of regions corresponding to the plurality of screens is simultaneously displayed in the touch screen 151 when the electronic device 100 is in the lock mode, the controller 180 may detect the generation of a predetermined event related to a specific one of the plurality of screens at step S600.

The predetermined event may comprise, for example, events related to the reception of external information, the completion of downloading, the completion of a setup task, and a call.

The reception of the external information may comprise, for example, the reception of a message, the reception of e-mail, the reception of update information related to SNS, and the reception of update information of various applications. The reception of the external information refers to the reception of information related to a specific one of the plurality of screens corresponding to the plurality of regions provided in the lock mode.

The reception of the information related to the specific screen may refer to the reception of information related to an application pertinent to the specific screen.

The completion of the downloading refers to a case where the downloading of data, such as contents requested by a user or automatically performed, is completed in the lock mode.

The completion of the setup task refers to a case where a task, set up by a user or automatically set up by the controller 180, is completed in the lock mode. Like the downloading of data, the setup task may be classified into a task according to the interaction with the outside of the electronic device 100 and a task performed within the electronic device 100.

The event related to the call refers to a case where a call is received or a case where a user does not answer a received call (that is, call during absence).

In addition to the above examples, the predetermined event may comprise all events which may occur in relation to the electronic device 100.

When the generation of the predetermined event pertinent to the specific screen is detected, the controller 180 may perform an operation of updating a region corresponding to the specific screen so that the event is reflected at step S610.

Furthermore, when the generation of the predetermined event pertinent to the specific screen is detected, the controller 180 may perform an operation of enlarging the size of a region corresponding to the specific screen at step S611.

The controller 180 may selectively perform any one of the operations at steps S610 and S611 or may perform both the operations.

For example, referring to FIG. 26, in case where a message is received in the state of FIG. 5, the controller 180 may update the second region 11 relating to a communication screen or a communication application pertinent to the reception of the message so that the reception of the message is reflected.

As shown in FIG. 26, the controller 180 may update the second region 11 so that the reception of the message is reflected by displaying information 40 about the received message in the second region 11.

Furthermore, the controller 180 may display the information 40 about the message in the second region 11 and simultaneously enlarge the size of the second region 11 greater than a size before the message is received.

Alternatively, the controller 180 may do not display the information 40 about the message, but enlarge only the size of the second region 11.

For another example, referring to FIG. 27, in case where new information is received through a specific SNS application, the controller 180 may update the fourth region 13 by enlarging the size of the fourth region 13 corresponding to an SNS screen and simultaneously displaying the received new information or information related to the received new information in the fourth region 13.

Meanwhile, in the variety of embodiments of this document, in case where the electronic device 100 is in the lock mode, the plurality of regions provided to the touch screen 151 may be arranged in various ways.

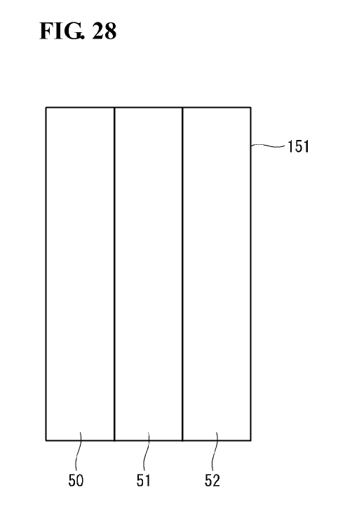

FIGS. 28 to 30 are diagrams illustrating examples in which the plurality of regions is arranged in various ways.

Referring to FIG. 28, the controller 180 may divide the touch screen 151 into a plurality of regions 50, 51, and 52 and make different screens correspond to the regions 50, 51, and 52.

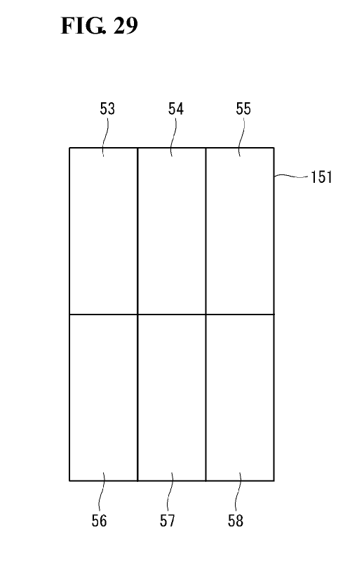

Alternatively, the controller 180 may provide a plurality of regions 53, 54, 55, 56, 57, and 58 corresponding to respective screens using a method, such as that shown in FIG. 29, to the touch screen 151 in the lock mode.

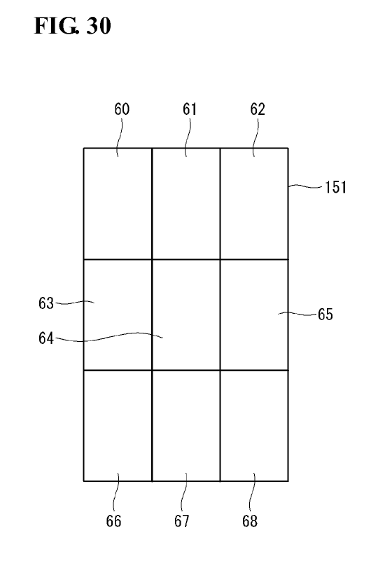

Alternatively, the controller 180 may provide a plurality of regions 60, 61, 62, 63, 64, 65, 66, 67, and 68 corresponding to respective screens using a method, such as that shown in FIG. 30, to the touch screen 151 in the lock mode.

The methods of controlling the electronic device according to the embodiments of this document may be recorded on a computer-readable recording medium in the form of a program for being executed in a computer and then provided.

The methods of controlling the electronic device according to the embodiments of this document may be executed through software. When the method is executed in software, the elements of this document are code segments that execute necessary tasks. The program or code segments may be stored in a processor-readable medium or may be transmitted through a transfer medium or a computer data signal combined with carriers over a communication network.

The computer-readable recording medium may comprise all kinds of recording devices on which data capable of being read by a computer system is recorded. For example, the computer-readable recording medium may comprise ROM, RAM, CD-ROM, DVD±ROM, DVD-RAM, magnetic tapes, floppy disks, hard disks, and optical data storages. The computer-readable recording medium may also have its codes, which are distributed into computer apparatuses connected over a network and readable by computers in a distributed manner, stored therein and executed.

The electronic device and the methods of controlling the electronic device according to this document have the following advantages.

According to this document, a user interface, enabling a user to easily and efficiently control an electronic device, may be provided to the user.

Furthermore, according to this document, a user interface, enabling a user to directly access a desired screen or a screen in which a desired application is executed in the state in which an electronic device is in a lock mode, may be provided to the user.

Furthermore, according to this document, in case where an event pertinent to an electronic device is generated when the electronic device is in the lock mode, a user may be efficiently informed of the generation of the event or the contents of the event or both.

The foregoing embodiments and advantages are merely exemplary and are not to be construed as limiting this document. The present teaching can be readily applied to other types of apparatuses. The description of the foregoing embodiments is intended to be illustrative, and not to limit the scope of the claims. Many alternatives, modifications, and variations will be apparent to those skilled in the art.

1. An electronic device, comprising:
a touch screen; and
a controller configured to display a plurality of regions on the touch screen when the touch screen is in a lock mode, the plurality of regions being corresponding to a plurality of screens and, when a predetermined touch action is received through the touch screen, to unlock the lock mode and enter a screen corresponding to a region corresponding to the received touch action, from among the plurality of regions.

2. The electronic device of claim 1, wherein the controller is configured to display image representing the corresponding screen on the specific region of the plurality of regions or to display icon related to the corresponding screen on the specific region.

3. The electronic device of claim 1, wherein when a touch action for a specific one of the plurality of regions is received, the controller is configured to unlock the lock mode and enter a screen corresponding to the specific region.

4. The electronic device of claim 3, wherein:
the touch action is a stroke action for the specific region, and
the stroke action comprises at least one of a drag action and a flicking action.

5. The electronic device of claim 4, wherein when the stroke action for the specific region satisfies at least one of a predetermined direction and a predetermined distance, the controller is configured to unlock the lock mode and enter the screen corresponding to the specific region.

6. The electronic device of claim 1, wherein when a stroke action started at a predetermined position on the touch screen is received, the controller is configured to unlock the lock mode and enter a screen corresponding to a region corresponding to the stroke action, from among the plurality of regions.

7. The electronic device of claim 6, wherein the predetermined position is a point where all the plurality of regions adjoins.

8. The electronic device of claim 7, wherein the controller is configured to enter a screen corresponding to a region which exists on an opposite side to a direction of the stroke action, from among the plurality of regions.

9. The electronic device of claim 8, wherein when the point where all the plurality of regions adjoins is touched, the controller is configured to display an indicator for indicating at least one direction where the stroke action can be performed, on the touch screen.

10. The electronic device of claim 1, wherein the controller is configured to receive a stroke through the touch screen and enter a screen corresponding to a region which exists on an opposite side to a direction where the stroke is performed, from among the plurality of regions.

11. The electronic device of claim 1, wherein when an operation of dragging a multi-touch is received through a specific one of the plurality of regions, the controller is configured to unlock the lock mode and enter a screen corresponding to the specific region.

12. The electronic device of claim 1, wherein when a predetermined event related to a specific one of the plurality of screens happens, the controller is configured to update a region corresponding to the specific screen in order to reflect the generated event.

13. The electronic device of claim 1, wherein when a predetermined event related to a specific one of the plurality of screens happens, the controller is configured to enlarge a size of a region corresponding to the specific screen.

14. The electronic device of claim 12, wherein the predetermined event comprises at least one of events which are related to a reception of external information, a completion of downloading, a completion of a setup task, and a call.

15. The electronic device of claim 1, wherein the plurality of screens comprises at least one of a screen predetermined by a user, a screen most recently executed, a screen related to an application having a highest frequency of use, and an idle screen.

16. A method of controlling an electronic device comprising a touch screen, the method comprising:
displaying a plurality of regions on the touch screen when the touch screen is in a lock mode, the plurality of regions being corresponding to a plurality of screens; and
when a predetermined touch action is received through the touch screen in the lock mode, unlocking the lock mode and entering a screen corresponding to a region corresponding to the received touch action, from among the plurality of regions.

17. The electronic device of claim 13, wherein the predetermined event comprises at least one of events which are related to a reception of external information, a completion of downloading, a completion of a setup task, and a call.
